(19) United States
(12) Patent Application Publication
(10) Pub. No.: US 2022/0104025 A1
(43) Pub. Date: Mar. 31, 2022

(54) SECOND FACTOR AUTHENTICATION FOR IOT DEVICES

(71) Applicant: Intel Corporation, Santa Clara, CA (US)

(72) Inventors: Arkadiusz Berent, Tuchom (PL); Mateusz Bronk, Gdansk (PL); Piotr Zmijewski, Gdansk (PL); Krystian Matusiewicz, Gdansk (PL)

(73) Assignee: Intel Corporation, Santa Clara, CA (US)

(21) Appl. No.: 17/546,413

(22) Filed: Dec. 9, 2021

(51) Int. Cl. H04W 12/50; H04W 12/033; H04L 9/08

(52) U.S. Cl. CPC H04W 12/50; H04L 9/085; H04W 12/033

(57) ABSTRACT

A method comprises discovering, in a controller device, one or more target devices that are in a pairing mode, generating, in the controller device, a first signal comprising a pattern, transmitting, from the controller device to a first remote device, the first signal comprising the pattern, receiving, in the controller device, a second signal from a second remote device, the second signal comprising a authentication code, and authenticating the one or more target devices when the first authentication signal and the second authentication signal match.

### BACKGROUND

Internet of Things (IoT) devices frequently do not have input/output (I/O) interfaces which are user friendly to humans. The process of adding IoT devices to a network is commonly based on putting such devices in a pairing mode in which the device advertises its presence and/or accepts join requests coming from the coordinator. The operation of joining a network assumes there is a single controller in the range of the IoT device to be ready for pairing. In densely populated areas there may be multiple controllers within range of the IoT device, and there is no uniform way to determine which controller should be selected.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified schematic diagram of an environment in which techniques for second factor authentication for IoT devices may be implemented, in accordance with an embodiment.

FIG. 2 is a simplified flow diagram of operations in a method to implement second factor authentication for IoT devices according to an embodiment.

FIG. 3 is a simplified schematic diagram of an environment in which techniques for second factor authentication for IoT devices may be implemented, in accordance with an embodiment.

FIG. 4 is a simplified is a simplified flow diagram of operations in a method to implement second factor authentication for IoT devices according to an embodiment.

FIG. 5 is a simplified schematic diagram of an environment in which techniques for second factor authentication for IoT devices may be implemented, in accordance with an embodiment.

FIG. 6 simplified is a simplified flow diagram of operations in a method to implement second factor authentication for IoT devices according to an embodiment.

FIG. 7 simplified is a simplified flow diagram of operations in a method to implement second factor authentication for IoT devices according to an embodiment.

FIG. 8 is a block diagram illustrating a computing architecture which may be adapted to provide a method for secure PUF-based authentication using adversarial challenge selection according to an embodiment.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device). In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

As described above, Internet of Things (IoT) devices frequently do not have input/output (I/O) interfaces which are user friendly to humans. The process of adding IoT devices to a network is commonly based on putting such devices in a pairing mode in which the device advertises its presence and/or accepts join requests coming from the coordinator. The operation of joining a network assumes there is a single controller in the range of the IoT device to be ready for pairing. In densely populated areas there may be multiple controllers within range of the IoT device, and there is no uniform way to determine which controller should be selected. This presents a security issue because the IoT device may inadvertently join an incorrect network.

To address these and other issues, described herein are systems and techniques to implement second factor authentication for IoT devices. In some examples both controllers and IoT devices may provide support for an additional bi-directional, out-of-band communication channel. This communication channel can be used to implement a second factor authentication process to ensure that only expected IoT devices join a controller's network, and that an IoT device only joins the correct network, even there are multiple controllers and devices belonging to different users within range. In some examples an IoT device may leverage existing features and/or inherent properties of the IoT device to create an out-of-band communication channel.

In some examples the device pairing process may be augmented with one or more additional authentication steps which use a communication channel other than radio frequency (RF) to send additional authentication information. The communication channel is referred to herein as an out-of-band (OOB) communication channel. In some examples the additional information sent via the OOB communication channel may include a proof of proximity and/or possession of the IoT device. In some examples the additional information may include a pattern of characters, symbols, images, and/or sounds that may be utilized to generate an authentication code which may be used to authenticate the IoT device. The OOB communication channel may be built using inherent device's properties. For example, a smart RGB light bulb could send a pattern by emitting sequence of different colors and/or brightness levels. The difference between subsequent colors and/or brightness levels could be visible to the naked human eye, for example a sequence of red-blue-green-red-blue. Alternatively, the difference could virtually indistinguishable to the naked human eye (e.g., slight white color temperature changes), but detectable by an electronic device such as a smartphone with a camera.

Systems and techniques described herein enable second factor authentication for IoT devices. Techniques are described to implement second factor authentication for devices which have a capability to emit information through an OOB communication channel (e.g., light in smart light bulb). Such devices could use their existing capabilities like emitting light to send additional authentication information via the OOB communication channel. The emitted authentication information may be detected by an auxiliary device such as a smartphone or smartwatch and forwarded to the controller using a radio frequency (RF) connection such as Wi-Fi, Bluetooth, or the like.

In addition, techniques are described to implement second factor authentication for devices which do not have a capability to emit information through an OOB communication channel (e.g., smart buttons or sensors which have pushbutton I/O interfaces). Such devices may use existing properties and/or I/O interfaces to receive a pattern via an OOB communication channel and may subsequently send it to the controller via a RF communication channel.

Two authentication techniques are provided for both of these categories of devices. The first technique is suited to low-power devices equipped with microcontrollers which are not capable of providing key derivation or in-band channel encryption (e.g., Z-Wave devices which do not support security class commands). The technique provides second factor authentication for the process of the IoT device join a network managed by a controller, which prevents accidental takeover of IoT devices by the wrong controller (e.g., in densely populated areas). The second technique is suitable for IoT devices which are capable of link encryption and key derivation (e.g., Z-Wave devices supporting Security-2 Class commands). In such case, techniques described herein enable mutual authentication between a controller and device during the process in which the IoT devices joins the network. Securing the communication channel during the pairing process also mitigates susceptibility to man-in-the-middle attacks. These technologies and techniques will be described with reference to the figures.

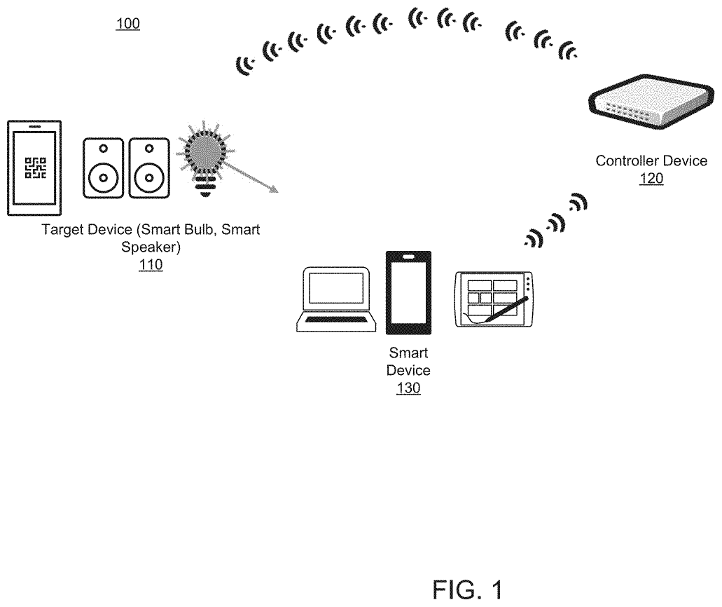

FIG. 1 is a simplified schematic diagram of an environment 100 in which techniques for second factor authentication for IoT devices may be implemented, in accordance with an embodiment. Referring to FIG. 1, in some examples, environment 100 comprises one or more target devices 110, a controller 120, and a smart device 130. In some examples the one or more target devices 110 may be embodied as an IoT device that comprises a RF communication interface to provide an RF connection with remote devices such as controller 120 and is capable to generate an out of band communication signal. In one example the target device(s) 110 may comprise one or more smart bulbs capable to generate an out of band communication signal in the visible light spectrum. In another example the target device(s) 110 may comprise one or more smart speakers capable to generate an out of band communication signal in an audible form. In another example the target device(s) may comprise sensor such as a camera or a medical sensor with a minimalist display capable to present a visual output such as a QR code or the like.

Controller device 120 may comprise a transmitter to transmit one or more electromagnetic signals and a receiver to receive one or more electromagnetic signals in the radio frequency (RF) domain to establish a communication connection with other devices. For example, controller 120 may comprise a Wi-Fi transmitter and receiver that operates according to a Wi-Fi protocol, a Z-Wave protocol, a ZigBee protocol, or a Bluetooth transmitter and receiver. It will be understood that other RF communication protocols may be used, including proprietary RF communication protocols. Controller device 120 further comprises one or more processors and/or processing circuitry to enable controller device 120 to manage a wireless network with one or more remote devices including one or more target device(s) 110.

In some examples the one or more smart device(s) 130 may be embodied as a processor-based computing device such as a computer, a mobile phone, a tablet device, or the like. Smart device 130 may comprise a transmitter to transmit one or more electromagnetic signals and a receiver to receive one or more electromagnetic signals in the radio frequency (RF) domain to establish a communication connection with other devices. For example, smart device 130 may comprise a Wi-Fi transmitter and receiver that operates according to a Wi-Fi protocol or a Bluetooth transmitter and receiver. It will be understood that other RF communication protocols may be used, including proprietary RF communication protocols. Smart device 130 further comprises one or more processors and/or processing circuitry to enable smart device 130 to perform various operations. Smart device 130 may further comprise one or more input/output (I/O) interfaces such as a microphone, an image capture device, or the like to detect OOB signals generated by the target device(s) 110.

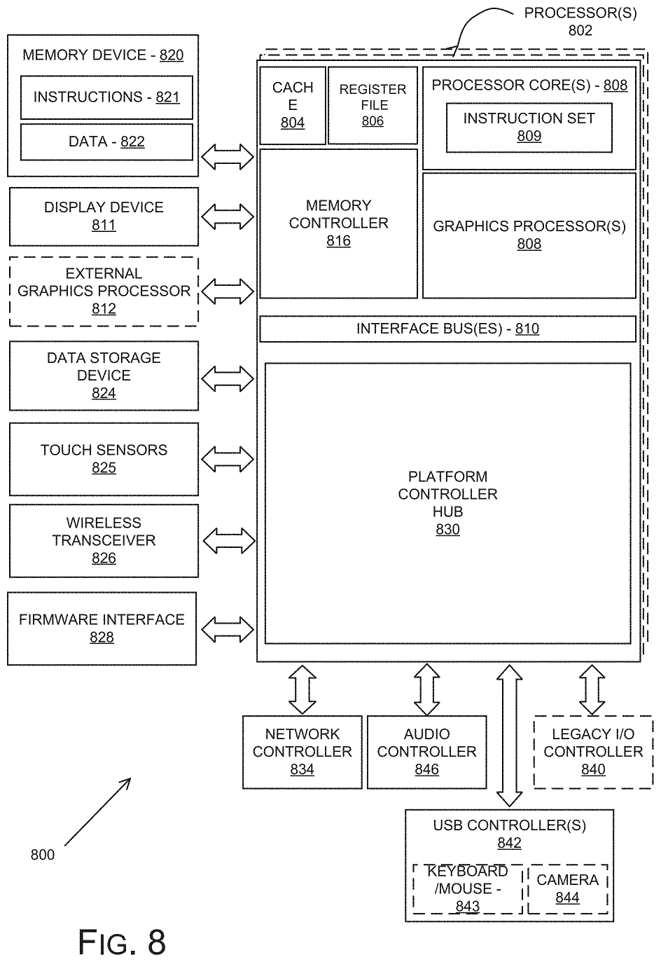

In some examples the various components of the environment 100 may be implemented by software-defined process that execute on a general-purpose processor, such as the system depicted in FIG. 8. In other examples the various components may be implemented in a configurable processing device such as a field programmable gate array (FPGA) or reduced to hard-wired circuitry.

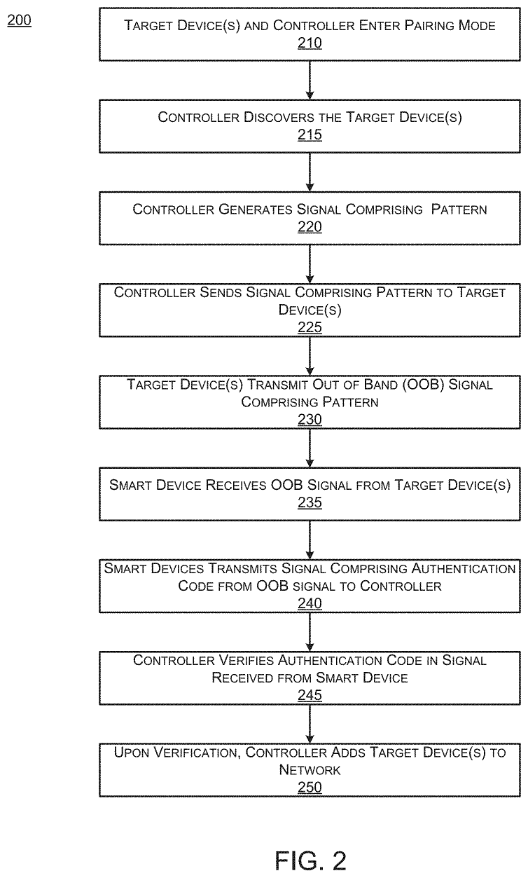

In accordance with aspects described herein, operations of the various components of environment 100 will be described with reference to the flowchart in FIG. 2, which is a simplified flow diagram of operations in a method to implement second factor authentication for IoT devices according to an embodiment. Referring to FIG. 2, at operation 210 the target device(s) 110 and the controller device 120 enter a pairing mode. At operation 215 the controller device 120 discovers the target device(s) 110, e.g., by detecting broadcast information transmitted by the target device(s) 110 over a radio channel.

At operation 220 the controller device 120 generates a signal comprising a pattern. In some examples the pattern may be a random sequence of digits and/or characters. At operation 225 the controller device 120 sends a signal comprising the pattern to the target device(s) 110. In some examples the controller device 120 transmits the signal via a RF communication channel.

The target device(s) 110 receive the signal and, at operation 230, transmit an OOB signal comprising an authentication code based on the pattern received by the target device(s) 110. In the embodiments depicted in FIG. 1 the smart bulb may generate a variation in a property of the light emitted by the smart bulb that corresponds to the pattern received by the smart bulb. Properties that can be varied include a brightness level of the smart bulb and/or a color output of the light bulb. In some examples the variation in a property of the light output by the bulb may not be perceptible to the naked human eye. Similarly, the smart speakers may generate a variation in a property of an audio output generated by the smart speakers that corresponds to the authentication code received by the smart speakers. Properties that can be varied include a volume level of the smart speakers and/or a frequency of the audio output. In some examples the variation in a property of the audio signal output by the smart speaker may not be perceptible to the naked human ear. Similarly, in some examples a device such as the phone depicted in FIG. 1 may present a visual signal comprising information about the authentication code. For example, a QR code representative of the authentication code may be presented on a display.

At operation 235 one or more smart devices 130 receives the OOB signal(s) generated comprising the pattern generated by the target device 110. In the case of the smart bulb the variation in a property of the light emitted by the smart bulb may be detected by an image capture device (e.g., a camera) on the smart device 130. In the case of the smart speakers a variation of an audio output generated by the smart speakers may be de detected by a microphone on the smart device. In the case of visual output such as the output on the sensor the visual output signal may be detected by an image capture device (e.g., a camera) on the smart device 130.

The OOB signal received by the smart device 130 may be processed by processing circuitry on the smart device and converted to an authentication code. At operation 240 the smart device 130 transmits a signal comprising the authentication code generated based on the OOB signal received from the target device 110 to the controller device 120, e.g., via a RF signal.

The controller device 120 receives the RF signal and, at operation 245, verifies the authentication code in the RF signal received from the smart device 130. In some examples the verification process involves comparing the pattern generated by the controller device 120 in operation 220 with the authentication code received from the smart device 130 in operation 240. If the authentication code matches the pattern, then the authentication code may be considered verified. By contrast, if the authentication code does not match the pattern, then the authentication code may be considered unverified. Upon verification, at operation 250, the controller device 120 adds the target device 110 to the network managed by the controller device.

Thus, the operations depicted in FIG. 2 enable a controller device 120 to authenticate a target device 110 that has a capability to generate an OOB signal before adding the target device 110 to a communication network managed by the controller device 120. However, some target devices may not have a capability to generate an OOB signal, which necessitates a different methodology.

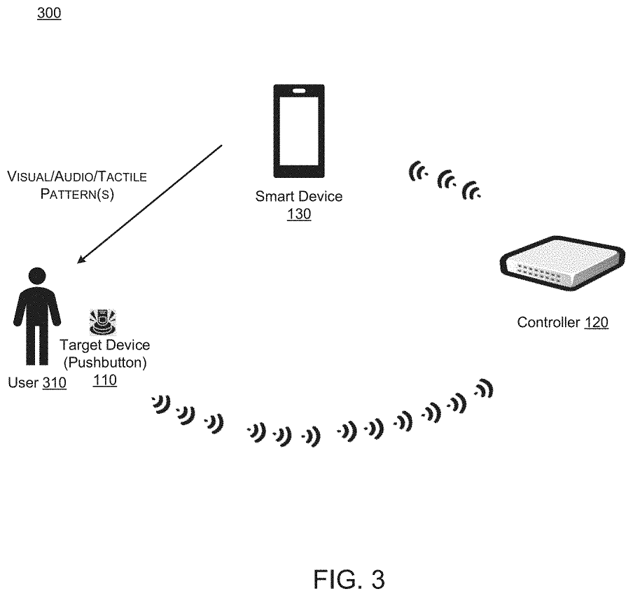

FIG. 3 is a simplified schematic diagram of an environment in which techniques for second factor authentication for IoT devices may be implemented, in accordance with an embodiment. Referring to FIG. 3, in one example environment 300 comprises one or more target devices 110, a controller device 120, and a smart device 130. In some examples the controller device 120 and the smart device 130 may be implemented as described above with reference to FIG. 1. However, the target device(s) 110 lack the capability to generate an OOB communication signal. In some examples the one or more target devices 110 may be embodied as an IoT device a tactile interface such as a push button interface.

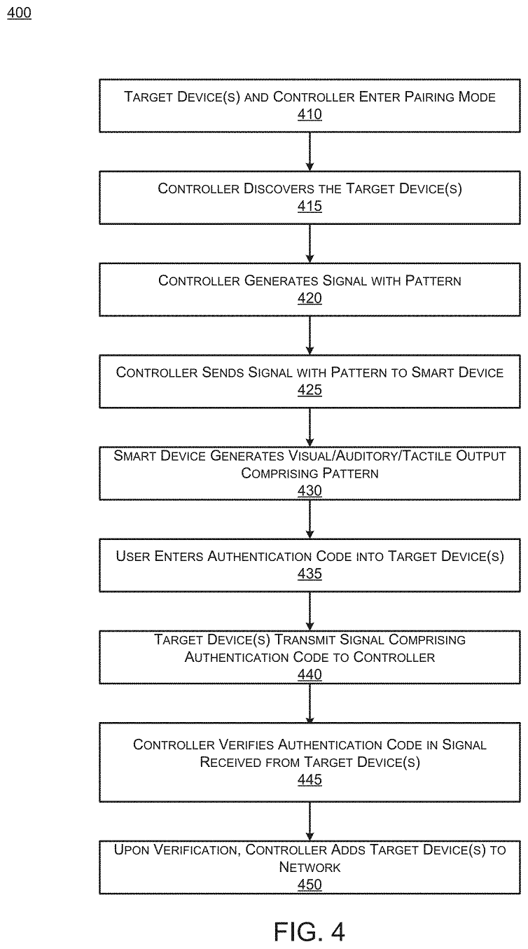

In accordance with aspects described herein, operations of the various components of environment 300 will be described with reference to the flowchart in FIG. 4, which is a simplified flow diagram of operations in a method to implement second factor authentication for IoT devices according to an embodiment. Referring to FIG. 4, at operation 410 the target device(s) 110 and the controller device 120 enter a pairing mode. At operation 415 the controller device 120 discovers the target device(s) 110, e.g., by detecting broadcast information transmitted by the target device(s) 110 over a radio channel.

At operation 420 the controller device 120 generates a signal comprising a pattern. In some examples the authentication code may be a random sequence of digits and/or characters. At operation 425 the controller device 120 sends a signal comprising the pattern to the smart device(s) 130. In some examples the controller device 120 transmits the signal via a RF communication channel.

The smart device(s) 130 receive the signal and, at operation 430, the smart device(s) 130 generates at least one of a visual output comprising an indicia of the pattern to be presented on a display, an audio output comprising an indicia of the authentication code to be presented on an audio output, or a tactile output comprising an indicia of the pattern. For example, the smart device may present a visual indication of a series of long dashes and short dashes, a series of long tones and short tones, or a series of long vibrations and short vibrations similar to a Morse code representation of the pattern.

At operation 435 a user 310 enters an input signal into the target device(s) 110, e.g., by depressing the push button in a sequence corresponding to the output signal generated by the smart device(s) 130. The input signal received by the target device(s) 110 may be processed by processing circuitry on the target device(s) 110 and converted to a authentication code. At operation 440 the target device(s) 110 transmit a signal comprising the authentication code generated based on the OOB signal received from the target device 110 to the controller device 120, e.g., via a RF signal.

The controller device 120 receives the RF signal and, at operation 445, verifies the authentication code in the RF signal received from the target device(s) 110. In some examples the verification process involves comparing the pattern generated by the controller device 120 in operation 420 with the authentication code received from the target device(s) 110 in operation 440. If the authentication code matches the pattern, then the authentication code may be considered verified. By contrast, if the authentication code does not match the pattern, then the authentication code may be considered unverified. Upon verification, at operation 450, the controller device 120 adds the target device 110 to the network managed by the controller device.

Thus, the operations depicted in FIG. 4 enable a controller device 120 to authenticate a target device 110 that does not have a capability to generate an OOB signal before adding the target device 110 to a communication network managed by the controller device 120.

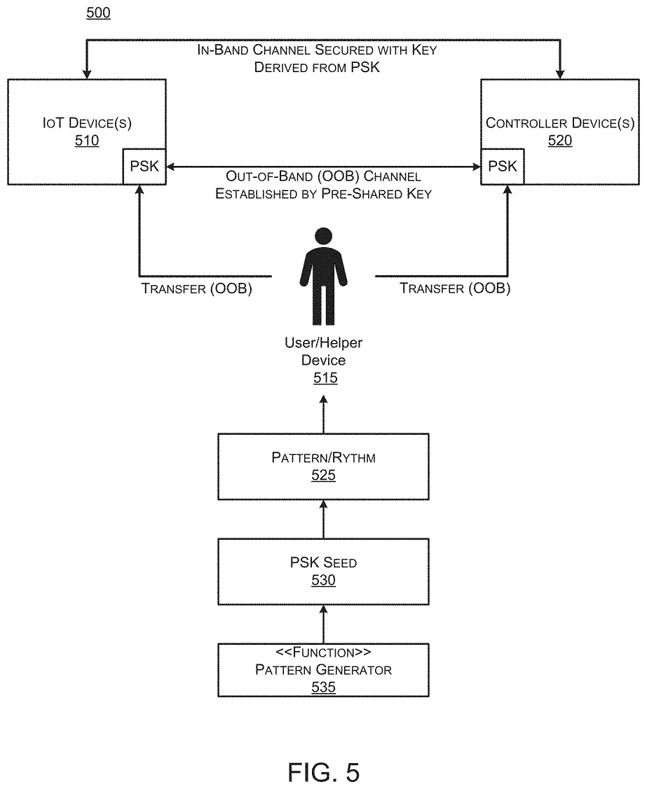

In some examples an IoT device may comprise the capability to implement an encrypted communication link with a controller during join operation. One such environment is depicted in FIG. 5, which is a simplified schematic diagram of an environment 500 in which techniques for second factor authentication for IoT devices may be implemented, in accordance with an embodiment. Referring to FIG. 5, in one example the environment 500 comprises one or more IoT devices 510 and one or more controller devices 520, which may be implemented as described above with reference to FIG. 1 and FIG. 3.

In one embodiment, the IoT device(s) 510 and the controller device(s) 520 are capable to provide an OOB communication channel that is used to establish a pre-shared key (PSK). In addition, an in-band communication channel may be secured (i.e., encrypted) using a key that is derived from the pre-shared key. In some examples, The PSK may be generated during the network join process by a pattern generator 535. In some examples the pattern generator may be implemented as a function which can be implemented by a capable device rather than a physical component.

In some examples the location of the pattern generator 535 depends on whether the IoT device 510 can emit data for the out-of-band channel. If the IoT device 510 is capable of emitting data in an OOB channel, as illustrated in the environment of FIG. 1, then the IoT device 510 is a likely candidate for performing the pattern generator function 535, as the PSK seed 530 can reside within the IoT device, thus alleviating the need to ingest it from external source—e.g., by repeatedly powering it on and off. By contrast, if the IoT device 510 lacks the capacity to emit data in an OOB channel, as illustrated in the environment of FIG. 3, then the IoT device 510 is not capable of emitting a pattern 525. In this case, the pattern generator role may be fulfilled by the controller device 520, or a trusted user or helper device 515.

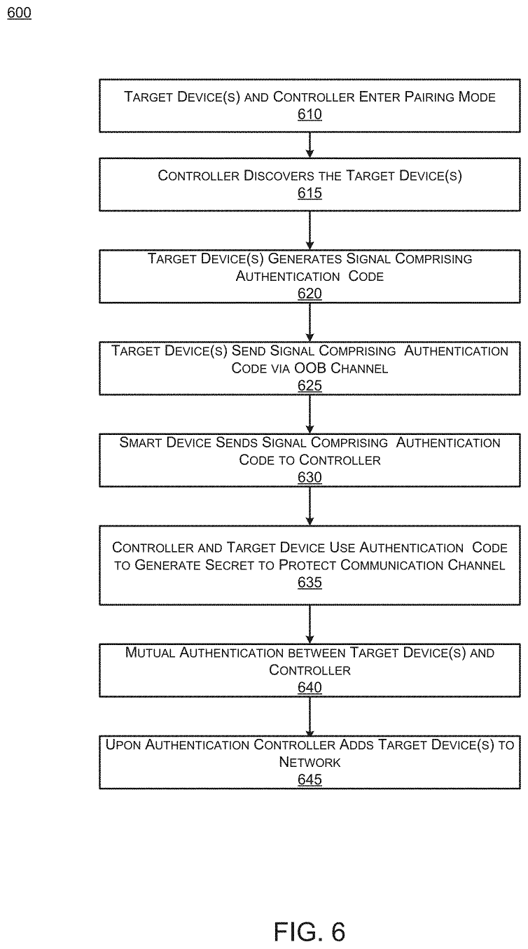

In accordance with aspects described herein, operations of the various components of environment 100 and environment 500 will be described with reference to the flowchart in FIG. 6, which is a simplified flow diagram of operations in a method to implement second factor authentication for IoT devices according to an embodiment. Referring to FIG. 6, at operation 610 the target device(s) 110 and the controller device 120 enter a pairing mode. At operation 615 the controller device 120 discovers the target device(s) 110, e.g., by detecting broadcast information transmitted by the target device(s) 110 over a radio channel.

At operation 620 the pattern generator 535 on the target device(s) 110 generates a signal comprising a pattern. In some examples the pattern code may be a random sequence of digits and/or characters. At operation 625 the target device(s) 110 sends a signal comprising the pattern to a helper device such as a smart device 130. For example, smart bulb may emit a series of pulses, which may be imperceptible to the naked human eye, by modulating the color ingredient intensity of the light. This information is then captured by a smart device 130 (e.g., a smart phone or smart watch with appropriate sensor such as a camera. In some examples, information about target device(s) 110 may be broadcasted directly by the target device(s) via a radio channel (or the smart device 130 could do this). This information may be used by the controller 120 to take additional steps described below. The pattern should be random.

At operation 630 one or more smart devices 130 receives the OOB signal(s) generated comprising the authentication code by the target device(s) 110. In the case of the smart bulb the variation in a property of the light emitted by the smart bulb may be detected by an image capture device (e.g., a camera) on the smart device 130. The OOB signal received by the smart device 130 may be processed by processing circuitry on the smart device 130 and converted to an authentication code. At operation 630 the smart device 130 transmits a signal comprising the authentication code generated based on the OOB signal received from the target device(s) 110 to the controller device 120, e.g., via a RF signal.

After the controller device 120 receives the authentication code transmitted by the smart device 130 in operation 630, both the target device(s) 110 and the controller device 120 know an authentication code. At operation 635 this authentication code may serve as a pre-shared secret seed to be used as an input to a key derivation function to create session key to protect RF communication channel between the target device(s) 110 and the controller device 120 during join operation.

At operation 640, mutual authentication is performed between the target device(s) 110 and the controller 120 using the secure communication channel established in operation 635. In some examples the authentication protocol may include cryptographic nonces (on both the target device 110, and controller device 120) to protect against reply attack. Only devices which have been successfully seeded with a PSK are able to communicate, and therefore to authenticate

At operation 645, upon a successful authentication the controller device 120 adds the target device 110 to the network managed by the controller device.

Thus, the operations depicted in FIG. 6 enable a controller device 120 to authenticate a target device 110 that has a capability to generate an OOB signal and to establish a secured communication connection before adding the target device 110 to a communication network managed by the controller device 120. However, some target devices 110 may not have a capability to generate an OOB signal, which necessitates a different methodology.

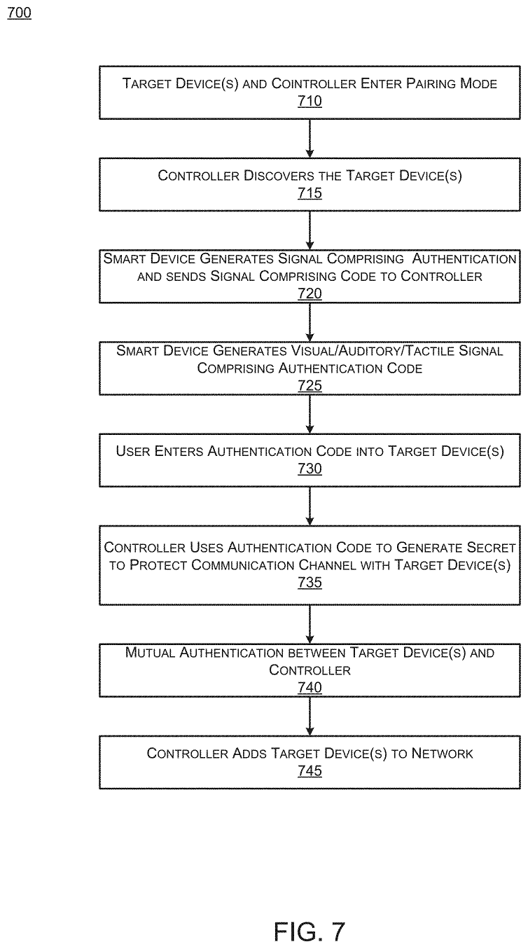

In accordance with aspects described herein, operations of the various components of environment 300 will be described with reference to the flowchart in FIG. 7, which is a simplified flow diagram of operations in a method to implement second factor authentication for IoT devices according to an embodiment. Referring to FIG. 7, at operation 710 the target device(s) 110 and the controller device 120 enter a pairing mode. At operation 715 the controller device 120 discovers the target device(s) 110, e.g., by detecting broadcast information transmitted by the target device(s) 110 over a radio channel.

At operation 720 the smart device 130, which includes the pattern generator 530, generates a signal comprising a pattern and sends a signal comprising the pattern to the controller 120. In some examples the smart device 130 transmits the signal via a RF communication channel. In some examples the pattern may be a random sequence of digits and/or characters.

At operation 725 the smart device 130 presents the pattern to the user via a user interface. In some examples the smart device generates at least one of a visual output comprising an indicia of the pattern to be presented on a display, an audio output comprising an indicia of the pattern to be presented on an audio output, or a tactile output comprising an indicia of the pattern. The pattern should be and sufficiently robust (e.g., with a correction code) so that a manual entry is possible. At the same time, the data carried by the pattern data should be long enough to provide desired number of bits (for security).

At operation 730 a user 310 enters an authentication code into the target device(s) 110, e.g., by depressing the push button in a sequence corresponding to the output signal generated by the smart device(s) 130. The input signal received by the target device(s) 110 may be processed by processing circuitry on the target device(s) 110 and converted to a authentication code.

After the user enters the authentication code presented by the smart device 130 in operation 730, both the target device(s) 110 and the controller device 120 know an authentication code. At operation 735 this authentication code may serve as a pre-shared secret seed to be used as an input to a key derivation function to create session key to protect RF communication channel between the target device(s) 110 and the controller device 120.

At operation 740, mutual authentication is performed between the target device(s) 110 and the controller 120 using the secure communication channel established in operation 735. In some examples the authentication protocol may include cryptographic nonces (on both the target device 110, and controller device 120) to protect against reply attack. Only devices which have been successfully seeded with a PSK are able to communicate, and therefore to authenticate

At operation 745, upon a successful authentication the controller device 120 adds the target device 110 to the network managed by the controller device.

Thus, the operations depicted in FIG. 7 enable a controller device 120 to authenticate a target device 110 that lacks a capability to generate an 00B signal but has to establish a secured communication connection before adding the target device 110 to a communication network managed by the controller device 120.

Exemplary Computing Architecture

FIG. 8 is a block diagram illustrating a computing architecture which may be adapted to implement a secure address translation service using a permission table (e.g., HPT 135 or HPT 260) and based on a context of a requesting device in accordance with some examples. The embodiments may include a computing architecture supporting one or more of (i) verification of access permissions for a translated request prior to allowing a memory operation to proceed; (ii) prefetching of page permission entries of an HPT responsive to a translation request; and (iii) facilitating dynamic building of the HPT page permissions by system software as described above.

In various embodiments, the computing architecture 800 may comprise or be implemented as part of an electronic device. In some embodiments, the computing architecture 800 may be representative, for example, of a computer system that implements one or more components of the operating environments described above. In some embodiments, computing architecture 800 may be representative of one or more portions or components in support of a secure address translation service that implements one or more techniques described herein.

As used in this application, the terms “system” and “component” and “module” are intended to refer to a computer-related entity, either hardware, a combination of hardware and software, software, or software in execution, examples of which are provided by the exemplary computing architecture 800. For example, a component can be, but is not limited to being, a process running on a processor, a processor, a hard disk drive or solid state drive (SSD), multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the unidirectional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 800 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 800.

As shown in FIG. 8, the computing architecture 800 includes one or more processors 802 and one or more graphics processors 808, and may be a single processor desktop system, a multiprocessor workstation system, or a server system having a large number of processors 802 or processor cores 807. In on embodiment, the system 800 is a processing platform incorporated within a system-on-a-chip (SoC or SOC) integrated circuit for use in mobile, handheld, or embedded devices.

An embodiment of system 800 can include, or be incorporated within, a server-based gaming platform, a game console, including a game and media console, a mobile gaming console, a handheld game console, or an online game console. In some embodiments system 800 is a mobile phone, smart phone, tablet computing device or mobile Internet device. Data processing system 800 can also include, couple with, or be integrated within a wearable device, such as a smart watch wearable device, smart eyewear device, augmented reality device, or virtual reality device. In some embodiments, data processing system 800 is a television or set top box device having one or more processors 802 and a graphical interface generated by one or more graphics processors 808.

In some embodiments, the one or more processors 802 each include one or more processor cores 807 to process instructions which, when executed, perform operations for system and user software. In some embodiments, each of the one or more processor cores 807 is configured to process a specific instruction set 814. In some embodiments, instruction set 809 may facilitate Complex Instruction Set Computing (CISC), Reduced Instruction Set Computing (RISC), or computing via a Very Long Instruction Word (VLIW). Multiple processor cores 807 may each process a different instruction set 809, which may include instructions to facilitate the emulation of other instruction sets. Processor core 807 may also include other processing devices, such a Digital Signal Processor (DSP).

In some embodiments, the processor 802 includes cache memory 804. Depending on the architecture, the processor 802 can have a single internal cache or multiple levels of internal cache. In some embodiments, the cache memory is shared among various components of the processor 802. In some embodiments, the processor 802 also uses an external cache (e.g., a Level-3 (L3) cache or Last Level Cache (LLC)) (not shown), which may be shared among processor cores 807 using known cache coherency techniques. A register file 806 is additionally included in processor 802 which may include different types of registers for storing different types of data (e.g., integer registers, floating point registers, status registers, and an instruction pointer register). Some registers may be general-purpose registers, while other registers may be specific to the design of the processor 802.

In some embodiments, one or more processor(s) 802 are coupled with one or more interface bus(es) 810 to transmit communication signals such as address, data, or control signals between processor 802 and other components in the system. The interface bus 810, in one embodiment, can be a processor bus, such as a version of the Direct Media Interface (DMI) bus. However, processor buses are not limited to the DMI bus, and may include one or more Peripheral Component Interconnect buses (e.g., PCI, PCI Express), memory buses, or other types of interface buses. In one embodiment the processor(s) 802 include an integrated memory controller 816 and a platform controller hub 830. The memory controller 816 facilitates communication between a memory device and other components of the system 800, while the platform controller hub (PCH) 830 provides connections to I/O devices via a local I/O bus.

Memory device 820 can be a dynamic random-access memory (DRAM) device, a static random-access memory (SRAM) device, flash memory device, phase-change memory device, or some other memory device having suitable performance to serve as process memory. In one embodiment the memory device 820 can operate as system memory for the system 800, to store data 822 and instructions 821 for use when the one or more processors 802 execute an application or process. Memory controller hub 816 also couples with an optional external graphics processor 812, which may communicate with the one or more graphics processors 808 in processors 802 to perform graphics and media operations. In some embodiments a display device 811 can connect to the processor(s) 802. The display device 811 can be one or more of an internal display device, as in a mobile electronic device or a laptop device or an external display device attached via a display interface (e.g., DisplayPort, etc.). In one embodiment the display device 811 can be a head mounted display (HMD) such as a stereoscopic display device for use in virtual reality (VR) applications or augmented reality (AR) applications.

In some embodiments the platform controller hub 830 enables peripherals to connect to memory device 820 and processor 802 via a high-speed I/O bus. The I/O peripherals include, but are not limited to, an audio controller 846, a network controller 834, a firmware interface 828, a wireless transceiver 826, touch sensors 825, a data storage device 824 (e.g., hard disk drive, flash memory, etc.). The data storage device 824 can connect via a storage interface (e.g., SATA) or via a peripheral bus, such as a Peripheral Component Interconnect bus (e.g., PCI, PCI Express). The touch sensors 825 can include touch screen sensors, pressure sensors, or fingerprint sensors. The wireless transceiver 826 can be a Wi-Fi transceiver, a Bluetooth transceiver, or a mobile network transceiver such as a 3G, 4G, Long Term Evolution (LTE), or 5G transceiver. The firmware interface 828 enables communication with system firmware, and can be, for example, a unified extensible firmware interface (UEFI). The network controller 834 can enable a network connection to a wired network. In some embodiments, a high-performance network controller (not shown) couples with the interface bus 810. The audio controller 846, in one embodiment, is a multi-channel high definition audio controller. In one embodiment the system 800 includes an optional legacy I/O controller 840 for coupling legacy (e.g., Personal System 2 (PS/2)) devices to the system. The platform controller hub 830 can also connect to one or more Universal Serial Bus (USB) controllers 842 connect input devices, such as keyboard and mouse 843 combinations, a camera 844, or other USB input devices.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system for facilitating hybrid communication according to embodiments and examples described herein.

Example 1 is method comprising discovering, in a controller device, one or more target devices that are in a pairing mode; generating, in the controller device, a first signal comprising a pattern; transmitting, from the controller device to a first remote device, the first signal comprising the pattern; receiving, in the controller device, a second signal from a second remote device, the second signal comprising an authentication code; and authenticating the one or more target devices when the pattern and the authentication code match.

Example 2 includes the subject matter of Example 1, wherein the controller device transmits the first signal comprising the pattern to the one or more target devices.

Example 3 includes the subject matter of Examples 1-2, wherein the one or more target devices transmit an out of band (OOB) signal comprising the authentication code.

Example 4 includes the subject matter of Examples 1-3, wherein the out of band (OOB) signal is transmitted via at least one of an electromagnetic signal in a frequency range visible to a human eye; an audio signal; or a visual signal.

Example 5 includes the subject matter of Examples 1-4, wherein the one or more target devices comprise a display to present a visual output comprising an indicia of the pattern; and the second remote device comprises an image capture device to capture an image of the visual output; processing circuitry to generate the authentication code from the image of the visual output; and a transmitter to transmit the authentication code to the controller device.

Example 6 includes the subject matter of Examples 1-5, wherein the controller device transmits the first signal comprising the pattern to the second remote device.

Example 7 includes the subject matter of Examples 1-6, wherein the one or more target devices comprise a tactile input interface to receive a tactile input comprising an indicia of the authentication code; and the second remote device comprises at least one of a display to present a visual output comprising an indicia of the pattern; an audio output to present an audible signal comprising an indicia of the pattern; or a tactile output to present a tactile signal comprising an indicia of the pattern.

Example 8 includes the subject matter of Examples 1-7, further comprising receiving, in the controller device, an encryption signal comprising an encryption seed; generating, in the controller device and based on the encryption seed, a session key to establish an encrypted communication channel between the controller and the second remote device.

Example 9 includes the subject matter of Examples 1-8, wherein the encrypted communication channel is secured using a secret derived from the encryption seed.

Example 10 includes the subject matter of Examples 1-9, further comprising adding the one or more target devices to a communication network managed by the controller device.

Example 11 is an apparatus comprising a transmitter to transmit one or more electromagnetic signals; a receiver to receive one or more electromagnetic signals; and processing circuitry to discover one or more target devices that are in a pairing mode; generate a first signal comprising a pattern; transmit the first signal comprising the pattern; receive a second signal from a second remote device, the second signal comprising a authentication code; and authenticate the one or more target devices when the first authentication signal and the second authentication signal match.

Example 12 includes the subject matter of Example 11, wherein the controller device transmits the first signal comprising the pattern to the one or more target devices.

Example 13 includes the subject matter of Examples 11-12, wherein the one or more target devices transmit an out of band (OOB) signal comprising the authentication code.

Example 14 includes the subject matter of Examples 11-13, wherein the out of band (OOB) signal is transmitted via at least one of an electromagnetic signal in a frequency range visible to a human eye; an audio signal; or a visual signal.

Example 15 includes the subject matter of Examples 11-14, wherein the one or more target devices comprise a display to present a visual output comprising an indicia of the pattern; and the second remote device comprises an image capture device to capture an image of the visual output; processing circuitry to generate the authentication code from the image of the visual output; and a transmitter to transmit the authentication code to the controller device.

Example 16 includes the subject matter of Examples 11-15, wherein the controller device transmits the first signal comprising the pattern to the second remote device.

Example 17 includes the subject matter of Examples 11-16, wherein the one or more target devices comprise a tactile input interface to receive a tactile input comprising an indicia of the authentication code; and the second remote device comprises at least one of a display to present a visual output comprising an indicia of the pattern; an audio output to present an audible signal comprising an indicia of the pattern; or a tactile output to present a tactile signal comprising an indicia of the pattern.

Example 18 includes the subject matter of Examples 11-17, further comprising instructions stored thereon that, in response to being executed, cause the computing device to receive, in the controller device, an encryption signal comprising an encryption seed; generate, in the controller device and based on the encryption seed, a session key to establish an encrypted communication channel between the controller and the second remote device.

Example 19 includes the subject matter of Examples 11-18, wherein the encrypted communication channel is secured using a secret derived from the encryption seed.

Example 20 includes the subject matter of Examples 11-19, further comprising instructions stored thereon that, in response to being executed, cause the computing device to add the one or more target devices to a communication network managed by the controller device.

In the description above, for the purposes of explanation, numerous specific details are set forth in order to provide a thorough understanding of the described embodiments. It will be apparent, however, to one skilled in the art that embodiments may be practiced without some of these specific details. In other instances, well-known structures and devices are shown in block diagram form. There may be intermediate structure between illustrated components. The components described or illustrated herein may have additional inputs or outputs that are not illustrated or described.

Various embodiments may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

Portions of various embodiments may be provided as a computer program product, which may include a computer-readable medium having stored thereon computer program instructions, which may be used to program a computer (or other electronic devices) for execution by one or more processors to perform a process according to certain embodiments. The computer-readable medium may include, but is not limited to, magnetic disks, optical disks, read-only memory (ROM), random access memory (RAM), erasable programmable read-only memory (EPROM), electrically-erasable programmable read-only memory (EEPROM), magnetic or optical cards, flash memory, or other type of computer-readable medium suitable for storing electronic instructions. Moreover, embodiments may also be downloaded as a computer program product, wherein the program may be transferred from a remote computer to a requesting computer.

Many of the methods are described in their most basic form, but processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments requires more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

What is claimed is:

1. A processor-implemented method, comprising:
discovering, in a controller device, one or more target devices that are in a pairing mode;
generating, in the controller device, a first signal comprising a pattern;
transmitting, from the controller device to a first remote device, the first signal comprising the pattern;
receiving, in the controller device, a second signal from a second remote device, the second signal comprising an authentication code; and
authenticating the one or more target devices when the pattern and the authentication code match.

2. The method of claim 1, wherein the controller device transmits the first signal comprising the pattern to the one or more target devices.

3. The method of claim 1, wherein the one or more target devices transmit an out of band (OOB) signal comprising the authentication code.

4. The method of claim 3, wherein the out of band (OOB) signal is transmitted via at least one of:
an electromagnetic signal in a frequency range visible to a human eye;
an audio signal; or
a visual signal.

5. The method of claim 1, wherein:
the one or more target devices comprise a display to present a visual output comprising an indicia of the pattern; and
the second remote device comprises:
an image capture device to capture an image of the visual output;
processing circuitry to generate the authentication code from the image of the visual output; and
a transmitter to transmit the authentication code to the controller device.

6. The method of claim 1, wherein the controller device transmits the first signal comprising the pattern to the second remote device.

7. The method of claim 6, wherein:
the one or more target devices comprise a tactile input interface to receive a tactile input comprising an indicia of the authentication code; and
the second remote device comprises at least one of:
a display to present a visual output comprising an indicia of the pattern;
an audio output to present an audible signal comprising an indicia of the pattern; or
a tactile output to present a tactile signal comprising an indicia of the pattern.

8. The method of claim 1, further comprising:
receiving, in the controller device, an encryption signal comprising an encryption seed;
generating, in the controller device and based on the encryption seed, a session key to establish an encrypted communication channel between the controller and the second remote device.

9. The method of claim 8, wherein the encrypted communication channel is secured using a secret derived from the encryption seed.

10. The method of claim 1, further comprising:
adding the one or more target devices to a communication network managed by the controller device.

11. An apparatus, comprising:
a transmitter to transmit one or more electromagnetic signals;
a receiver to receive one or more electromagnetic signals; and
processing circuitry to:
discover one or more target devices that are in a pairing mode;
generate a first signal comprising a pattern;
transmit the first signal comprising the pattern;
receive a second signal from a second remote device, the second signal comprising a authentication code; and
authenticate the one or more target devices when the first authentication signal and the second authentication signal match.

12. The apparatus of claim 11, wherein the apparatus transmits the first signal comprising the pattern to the one or more target devices.

13. The apparatus of claim 11, wherein the one or more target devices transmit an out of band (OOB) signal comprising the authentication code.

14. The apparatus of claim 13, wherein the out of band (OOB) signal is transmitted via at least one of:
an electromagnetic signal in a frequency range visible to a human eye;
an audio signal; or
a visual signal.

15. The apparatus of claim 11, wherein:
the one or more target devices comprise a display to present a visual output comprising an indicia of the pattern; and
the second remote device comprises:
an image capture device to capture an image of the visual output;
processing circuitry to generate the authentication code from the image of the visual output; and
a transmitter to transmit the authentication code to the controller device.

16. The apparatus of claim 11, wherein the controller device transmits the first signal comprising the pattern to the second remote device.

17. The apparatus of claim 16, wherein the one or more target devices comprise a tactile input interface to receive a tactile input comprising an indicia of the authentication code; and
the second remote device comprises at least one of:
a display to present a visual output comprising an indicia of the pattern;
an audio output to present an audible signal comprising an indicia of the pattern; or
a tactile output to present a tactile signal comprising an indicia of the pattern.

18. The apparatus of claim 11, the processing circuitry to:
receive an encryption signal comprising an encryption seed;
generate, based on the encryption seed, a session key to establish an encrypted communication channel between the apparatus and the second remote device.

19. The apparatus of claim 18, wherein the encrypted communication channel is secured using a secret derived from the encryption seed.

20. The apparatus of claim 11, the processing circuitry to:
add the one or more target devices to a communication network managed by the controller device.

21. A non-transitory computer readable medium comprising instructions which, when executed by a processor, cause the processor to
discover, in a controller device, one or more target devices that are in a pairing mode;
generate, in the controller device, a first signal comprising a pattern;
transmit, from the controller device to a first remote device, the first signal comprising the pattern;
receive, in the controller device, a second signal from a second remote device, the second signal comprising a authentication code; and
authenticate the one or more target devices when the first authentication signal and the second authentication signal match.
